(19) United States
(12) Patent Application Publication
(10) Pub. No.: US 2019/0392086 A1
(43) Pub. Date: Dec. 26, 2019

(54) Methods and Systems to Model Undiscovered Accumulations

(71) Applicant: Erik Thomas ANDERSON, Girdwood, AK (US)

(72) Inventor: Erik Thomas ANDERSON, Girdwood, AK (US)

(21) Appl. No.: 16/248,765

(22) Filed: Jan. 15, 2019

Related U.S. Application Data
(60) Provisional application No. 62/617,560, filed on Jan. 15, 2018.

(51) Int. Cl. G06F 17/40

(52) U.S. Cl. CPC G06F 17/40; G06F 2219/10

(57) ABSTRACT

Methods and systems to spatially model individual features or accumulations which are undiscovered but conceptualized or expected to exist sporadically within areas. These include physical properties, materials, minerals, environmental contamination, organisms, and energy of all types. The model(s) may be used to optimize technical concerns with respect to these features such as hydrocarbon accumulations. The resulting model(s) may improve efficiency of investments in acquisition of mineral interests, exploration well locations among other uses.

### BACKGROUND

Undiscovered resources are defined by the United States Geological Survey (USGS) as resources postulated, on the basis of geologic knowledge and theory, to exist outside of known fields or accumulations. Undiscovered resources may include resources from undiscovered pools within known fields, to the extent that they occur within separate plays. A prospect, on the other hand, is defined as a potential accumulation sufficiently well-defined to represent a viable drilling target.

The USGS provides numbers and sizes of undiscovered accumulations assessed/theorized to exist in plays. Undiscovered resources assessments generally estimate resource quantities to assessment unit areas (i.e. plays), where the resources are presumed to occur in accumulations of varying quantities.

A variety of engineering and scientific problems revolve around the search for undiscovered accumulations of natural resources.

It would be useful to geographically map potential locations of undiscovered accumulations within a play, and to determine likelihoods/probabilities that undiscovered accumulations exist at the potential locations.

### BRIEF DESCRIPTION OF THE DRAWINGS/FIGURES

FIG. 1 is a flowchart of a method of modelling undiscovered accumulations.

FIG. 2 is an illustration of a geographically defined play within an area.

FIG. 3 is an expanded view of a portion the of area 200 of FIG. 2, over which a uniformly distributed grid of reference locations is plotted.

FIG. 4 is an illustration of another play that includes an area of analysis.

FIG. 5 is an illustration of a contour map of the area of analysis, generated from grid nodes populated with the sum of the probabilities of any remaining undiscovered accumulations.

FIG. 6 is an illustration of another contour map of the area of analysis, generated from nodes populated with the sum of the risked (i.e., EV volumes), of any potential accumulations intersecting them.

FIG. 7 is an illustration of a geographic map of the area of analysis to illustrate impact to resource economics from growth of infrastructure.

FIG. 8 is another illustration of the geographic map of the area of analysis, to illustrate undiscovered accumulations intersecting assets of a leaseholder in terms of total volumes in each size class and volume of the percentage of the accumulation that would be contained by the leasehold.

FIG. 9 is a graph of expected volumes, size class, and average percentage of accumulation under lease (by volume), for the example of FIG. 8.

FIG. 10 is a graph of regression analysis using observed success rate for wells ranked according to model predicted discovery volumes.

FIG. 11 is a process flowchart of another method of modeling modelling undiscovered accumulations.

FIG. 12 is an illustration of a geographic map containing an assessment unit (e.g., a play), a grid of points, and multiple instances of a geometric shape that fit within the assessment unit.

FIG. 13 is a block diagram of a computer system configured to model an assessment of an undiscovered resource.

FIG. 14 is an image of a graphical user interface to a computer system, which may be presented at a user-interactive display of the computer system of FIG. 13.

FIG. 15 is an example assessment of undiscovered resources.

In the drawings, the leftmost digit(s) of a reference number identifies the drawing in which the reference number first appears.

### DETAILED DESCRIPTION

Disclosed herein are methods and systems to spatially model undiscovered accumulations, such as in petroleum plays. Methods and systems disclosed herein may be useful, for example, to provide natural resource managers new insights into the disposition and value of those resources, and practical procedures to fulfill land management objectives.

Also disclosed herein are methods and systems to map or model locations of undiscovered accumulations within a play, and to estimate likelihoods/probabilities that the undiscovered accumulations exist at the respective locations. Undiscovered resources may, for example, be modelled as a set of probabilistically weighted accumulations. In an embodiment, modeling techniques disclosed herein are applicable to spatial and probabilistic modelling of undiscovered resources, as opposed to prospects.

Also disclosed herein are methods and systems to model or estimate characteristics of the undiscovered accumulations as they relate spatially to other technical considerations. Undiscovered resources may, for example, be modelled as a set of probabilistically weighted accumulations (“modelled accumulations”), which may be further characterized by relating them to one or more technical considerations of interest.

Undiscovered accumulations may include undiscovered accumulations of natural resources (e.g., hydrocarbons, minerals, metals, materials, and/or other commodities), undiscovered physical properties (e.g., undiscovered geological features), undiscovered deposits of environmental contamination, undiscovered extraterrestrial accumulations (e.g., galaxies, planetary bodies, stars, gasses/nebula, and/or other extraterrestrial features), undiscovered organisms (e.g., accumulations of pests and/or bacteria), and undiscovered accumulation of one or more types of energy.

For illustrative purposes, examples are presented herein with respect to geological (e.g., hydrocarbon) accumulations. Methods and systems disclosed herein are not, however, limited in application to hydrocarbon accumulations, or other geological accumulations.

Mapping of hydrocarbon resources is a complicated matter, as these resources often occur in various states of uncertainty, which include undiscovered accumulations and prospective accumulations (i.e., a potential accumulation that is sufficiently well-defined to represent a viable drilling target). Undiscovered resources may also include resources from undiscovered pools within known fields.

Also disclosed herein are techniques to utilize undiscovered resources data directly in evaluations. Among other uses this allows for estimating the likelihood of finding these accumulations and the characteristics of those accumulations as they relate spatially to other technical considerations.

For example, businesses engaged in finding of oil and gas often invest heavily in areas with significant undiscovered resources. These businesses have the challenging task of optimizing a portfolio of mineral properties under great uncertainty as to how the spatial distribution of these interests intersect with this resource class in practical business terms. This is particularly true in areas where a significant portion of the readily identifiable prospects, often structural traps, have already been discovered and the opportunities in the basin shift to more stratigraphic traps often described as “subtle” as they are not easily discernable in seismic data.

Among possible uses of these probabilistic features is the estimation of the likelihood of intercepting a random accumulation with a well across an area of interest. This value is usually disregarded completely in conventional workflows and is not used, either on its own, or in support of a more complete economic valuation of an exploration well associated with another prospect. The combination of these elements using the system detailed herein allows for the mathematical conceptualization of undiscovered resources as probabilistic accumulations so that these can be more realistically evaluated as they would be expected to occur in space among other important technical considerations.

Technical considerations might include such things as mineral interests, potential exploration wells, development costs, known prospects and existing geoscientific information. Some of these may affect the non-geologic characteristics of the expected accumulations such as development costs or ownership of the undiscovered accumulations in an area but not their geological character such as size or probability of occurrence.

On the other hand, certain technical considerations such as geoscientific information may be used to improve the modelling of the undiscovered accumulations in an area. For example, scenarios may consider the effect which existing exploration wells may have on the volume of remaining undiscovered resources in an area. Example are presented herein to illustrate these functional aspects in characterization and analysis of the modelled accumulations.

Methods and systems disclosed herein may thus be used to manage business concerns in situations involving such resources, where the location and quantity of the underlying assets are uncertain and occur within a complex landscape of other technical considerations. This allows the business to holistically optimize mineral property acquisition and exploration program design for the resources.

Unless specified otherwise herein, the term “assessed number of accumulations” refers to a number of undiscovered accumulations estimated to be in a play and size class.

Unless specified otherwise herein, the terms “potential accumulations” and “undiscovered accumulation features” refer to spatial features generated to represent undiscovered accumulations, which may be specific to play and size class. These have a probability that may be specific to play and size class combination.

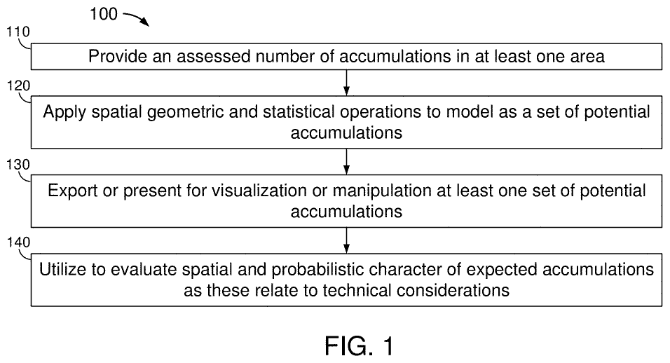

FIG. 1 is a flowchart of a method 100 of modelling undiscovered accumulations.

Method 100 incorporates complete spatial randomness with stochastic geometry. In this model, accumulations may exist anywhere in a play and the size of the accumulations are predicted probabilistically. A play polygon area is treated as the space within which any accumulation pertaining to that play may exist. In an embodiment, it is assumed that no part of an accumulation may extend beyond the play area. Method 100 presents the sum of all possible outcomes of the system, simultaneously, also referred to herein as a quantum superposition of the accumulations.

Method 100 begins with types of information provided in undiscovered resource assessments related to geographically defined areas, such as assessment units (AU) or plays, such as, those conducted and reported by the United States Geological Survey (USGS).

At 110, an assessed number of accumulations in at least one play is provided, accessed, and/or otherwise obtained. Associated assessment information may include the number and size of expected accumulations related to these plays or other information from which this could be inferred.

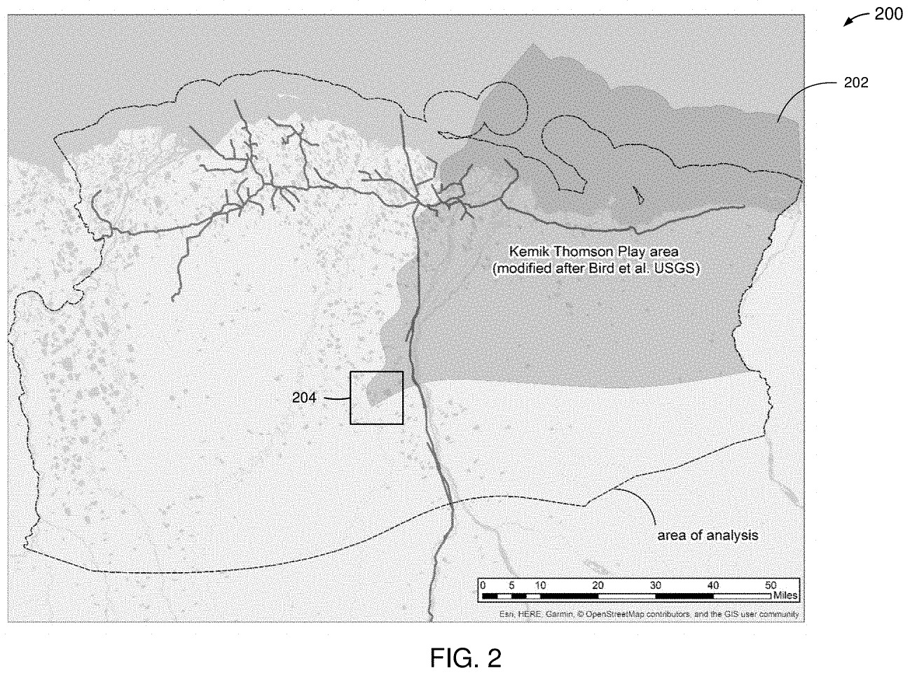

FIG. 2 is an illustration of an example geographically defined play 202 within an area 200.

Returning to FIG. 1, at 120, spatial geometric and statistical operations are performed to model the assessment information as a set of potential accumulations. In an embodiment, for each play 202, a representative set of analog accumulation geometries is created based on the accumulation size frequency distribution for the play.

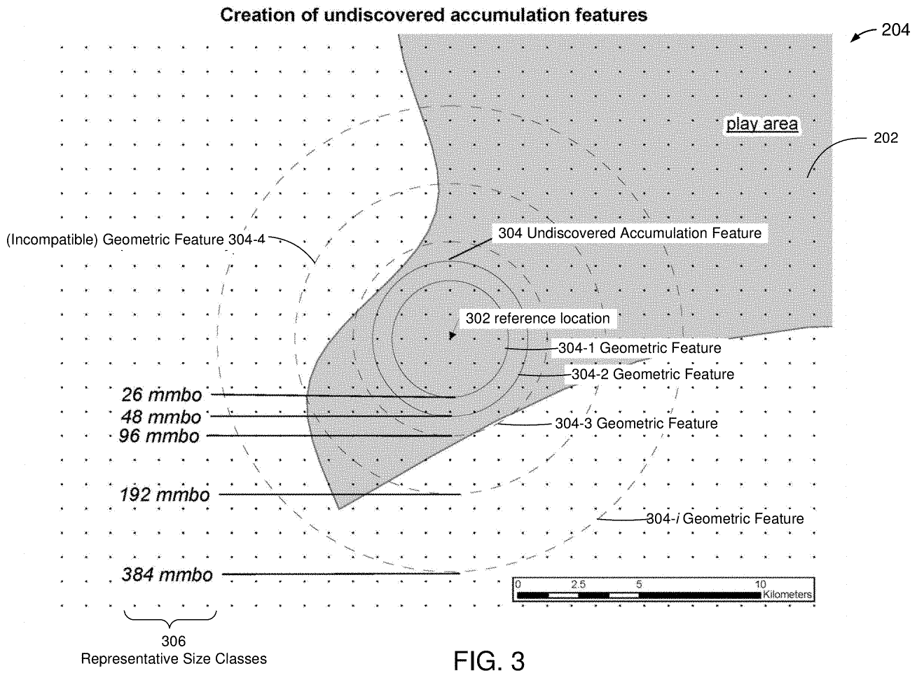

As in other areas of geosciences, analogs may be useful in development of conceptual models where certain information is unknown. Through a series of spatial, geometric, and statistical operations described below with reference to FIG. 3, the assessment information of 110 may be transformed from a single play polygon into a set of potential accumulations. Processing at 120 may be designed to exploit certain statistical laws and spatial mechanics to quantify statistical probability of occurrence for each of the potential accumulations. This may expand options for spatial conceptualization or presentation of the undiscovered accumulations, described below with reference to 130. This in turn may allow for accurate and logical characterization of the resources with respect to other technical considerations similarly, such as described below with reference to 140.

FIG. 3 is an expanded view of a portion 204 of area 200 (FIG. 2), over which a uniformly distributed grid of reference locations is plotted.

At 120 in FIG. 1, for each of one or more representative size classes 306, a corresponding geometric feature 304 is evaluated at a reference location 302 within play 202.

Reference location 302 may be considered a possible centroid location of an accumulation of one or more size classes 306 if the geometric feature 304 of the size class falls entirely within play 202. In the example of FIG. 3, geometric features 304-1 and 304-2 fall entirely within play 202. Reference location 302 may thus be considered a possible centroid location of an accumulation of 26 million barrels of oil (mmbo), and of an accumulation of 48 mmbo. Consequently, geometric features 304-1 and 304-2 are included in a set of potential undiscovered accumulations.

Geometric features 304-3, 304-4, and 304-i, do not fall entirely within play 202. Reference location 302 may thus be considered incompatible for accumulations of 96 mmbo, 192 mmbo, and 384 mmbo. Consequently, geometric features 304-3, 304-4, and 304-i, are are not included in the set of potential undiscovered accumulations.

As shown in FIG. 3, a given reference location (e.g., reference location 302), may be encompassed by multiple different accumulation geometries (e.g., geometric features 304).

Although not illustrated in FIG. 3, other reference locations within play 202 may be evaluated in a similar fashion.

Spacing between reference locations in FIG. 3 may be selected to provide suitable spatial resolution and accuracy, while allowing for analysis of relatively large areas without consuming excessive computing resources. In an embodiment, a grid spacing of a kilometer or less is utilized.

Further at 120 in FIG. 1, the assessed number of accumulations are distributed equally among the remaining potential accumulations in the set. This represents the individual chance of occurrence each potential accumulation in the set has. A potential accumulation may be further quantified in other statistical terms such as, without limitation, the expected volume the accumulation represents given its likelihood of existing. The expected value (EV) for the volume of each potential accumulation may be calculated as the expected volume of the potential accumulation multiplied by a fraction representing the probability of occurrence.

At 130 in FIG. 1, the set of potential accumulations is presented for visualization and/or manipulation. Since the set of potential accumulations constitute a high density of coincident spatial features, the set is not easily presentable for visualization and/or manipulation. Thus, in an embodiment, the underlying data points are aggregated based on uniform geographic cells, each represented with a single value. For example, nodes of a grid may be populated with values based on a statistical aggregation of the potential accumulations which they intersect. After assigning these values to the grid nodes, the values may be contoured.

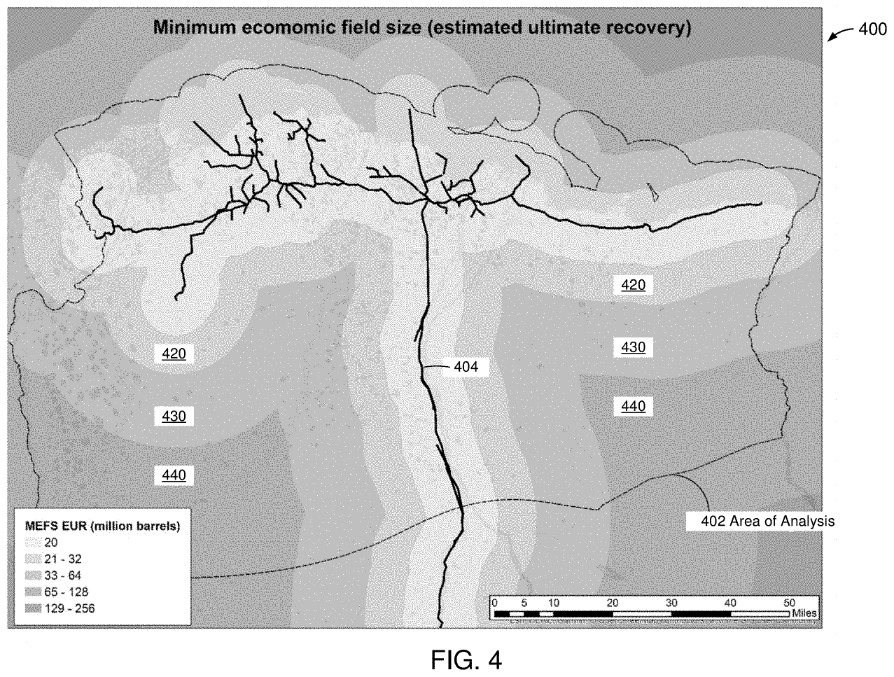

At 140, the set of potential accumulations may be integrated with other spatial information, such as factors and scenarios anticipated to impact the underlying commercial value of and/or revising the expected probability of the potential accumulations. Examples are provided below with reference to FIGS. 4-6.

FIGS. 4-6 illustrate an example series of maps that may be used to model the distribution of undiscovered resources as accumulations, respecting to the physical limits in both the play and accumulation geometry.

FIG. 4 is an illustration of a play 400 that includes an area of analysis 402. Within area of analysis 402, development costs for a resource may be determined with respect to a minimum economic field size (MEFS). The development costs may be a function of a distance to an existing pipeline system 404. For example, play 400 may be divided into regions 420, 430, and 440 of respective minimum economic size for accumulations, illustrated here as 20, 32, 64 and 128 mmbo, respectively.

In this distribution, the likelihood of already existing wells to have reduced the undiscovered resources occurring at locations is accounted for. In this scenario any accumulation with a well existing within the feature (accumulation geometry) is assumed to have been converted. Either to reserves, or a sub-economic accumulation or no accumulation was found. As these wells occur in both time and space it is possible to evaluate each well and how it was located with respect to the remaining resources from the point in time when the well was drilled.

This bears similarity to a concept in quantum mechanics called “wave function collapse” whereby the act of observation (i.e. testing) affects the system causing the set of probabilities to reduce. In this case, the reduction of possibilities is incremental with each observation location.

The lack of undiscovered resources potential does not imply a lack of reserves, notably the supergiant Prudhoe Bay Oil field (oil accumulation) occupies an area which this analysis assessed to have little remaining undiscovered resources primarily due to the density of wells.

The vintage of the field development infrastructure is a main factor of the effective well density, with the more modern fields tending to have lower well density as the reservoir area is developed by directionally drilling from fewer drilling pads. As such, the modelled set of undiscovered accumulations may be filtered to exclude potential accumulations intersected by existing wells. This tends to avoid overestimation of remaining undiscovered resources in situations with tested locations.

These operations and assumptions resulted in a set of approximately 300,000 undiscovered accumulation (GIS features) remaining.

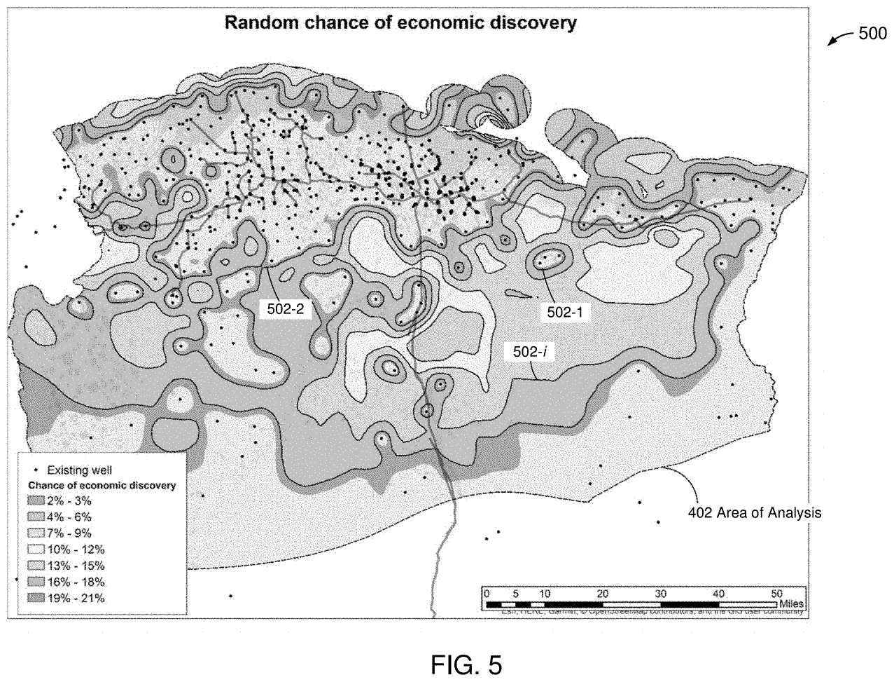

FIG. 5 is an illustration of a contour map 500 of area of analysis 402 (FIG. 4), generated from grid nodes populated with the sum of the probabilities of any remaining undiscovered accumulations. The values were interpolated using non-geostatistical methods, specifically, Inverse Distance Weighted estimation, as the data was at regularly spaced locations. This effectively quantifies the chance that a hypothetical well located at that position would successfully intersect a randomly occurring undiscovered economic accumulation based on assumptions and inputs described above. Each contour line 502 on map 500 indicates an area within area of interest 402 where the probability value of a respective feature is constant. In the example of FIG. 5, contour lines 502 are defined to occur at an interval of 3%. Note the impact of existing wells in connection with the filtering procedure described further above.

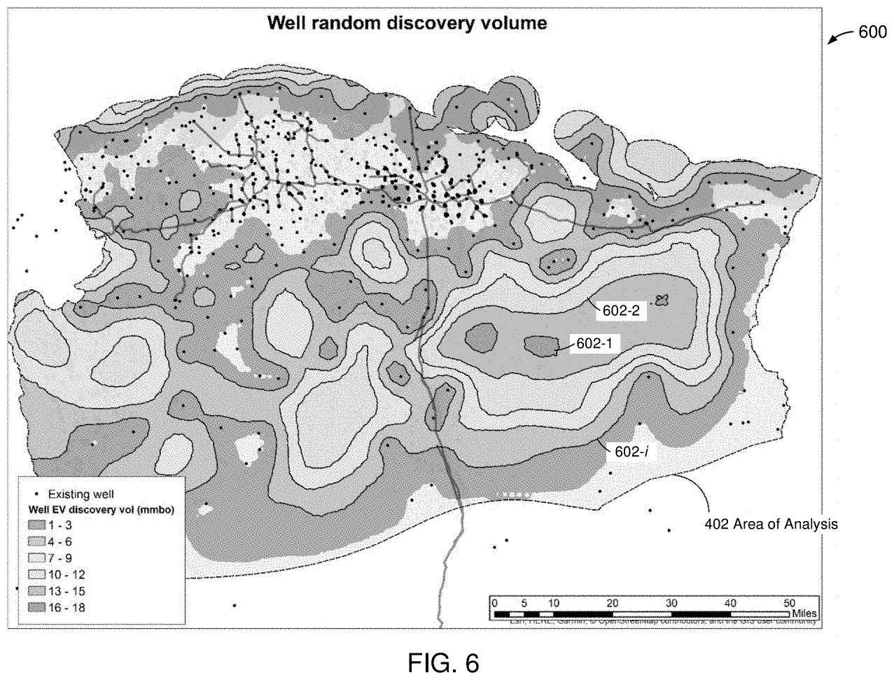

FIG. 6 is an illustration of a contour map 600 of area of analysis 402 (FIG. 4), generated from nodes populated with the sum of the risked (i.e., EV volumes), of any potential accumulations intersecting them. This may be interpreted as the sum of all expected volumes contained in any accumulations coincident with that location.

Understanding that perhaps only a fraction of such wells might make a discovery, the expected volume per well may include successful wells which make discoveries, and dry holes. In the example of FIG. 6, contour lines 602 are defined to occur at an interval of 3 million barrels of oil. In some areas, the next exploration well may be expected to find over 17 million barrels, on average, from the underlying undiscovered and untested accumulations.

Methods and systems disclosed herein may be useful to integrate economic filtering of a resource and exploration risk mitigation method to avoid overestimation of resource potential in tested areas. This permits visualization of spatial distribution of economic resources by risked volumes and/or other derivatives of the underlying undiscovered accumulations.

Methods and systems disclosed herein may be used to quantify changes to resource development potential from infrastructure growth. For example, governments with resources in remote or challenging terrain often want some way of assessing the value of infrastructure in terms of how it increases the economics of resources. With undiscovered resources, this can be a complex problem as these resource class is most accurately perceived in probabilistic terms.

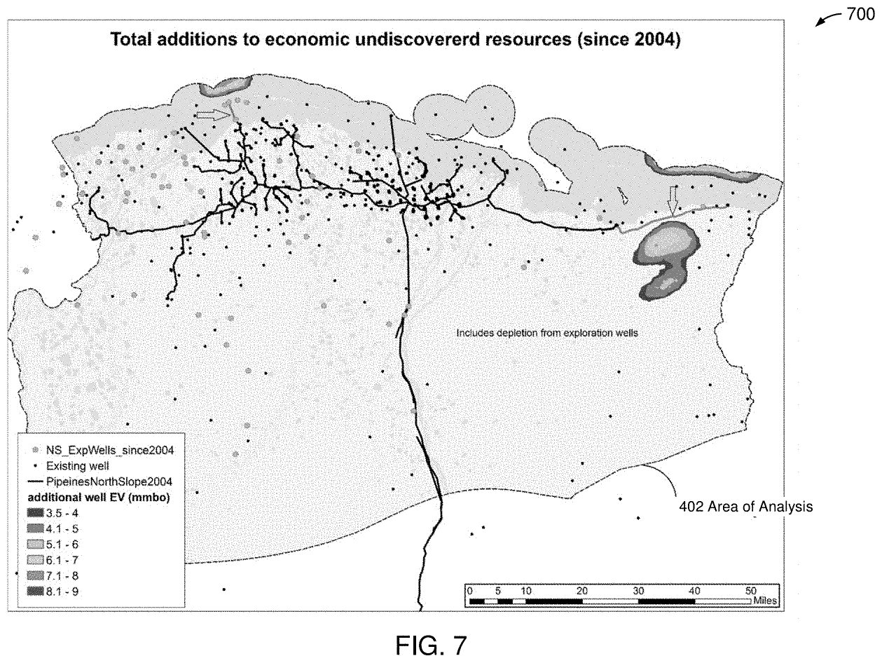

FIG. 7 is an illustration of a geographic map 700 of area of analysis 402 (FIG. 4), to illustrate impact to resource economics from growth of infrastructure. This example shows one such problem where the impact to the economics of undiscovered resources is quantified for recent expansions of pipeline infrastructure (arrows 702 illustrate expansions). This visualization includes products similar to those in FIGS. 5 and 6, but instead using only those accumulations which changed status from uneconomic to economic in this time period. This is the net additions and does not include any accumulations which were tested by any wells. Proposed or recently expanded infrastructure may be associated to the resources which would be expected to become economic. This may be used to assess impacts for real or hypothetical expansion or system optimization.

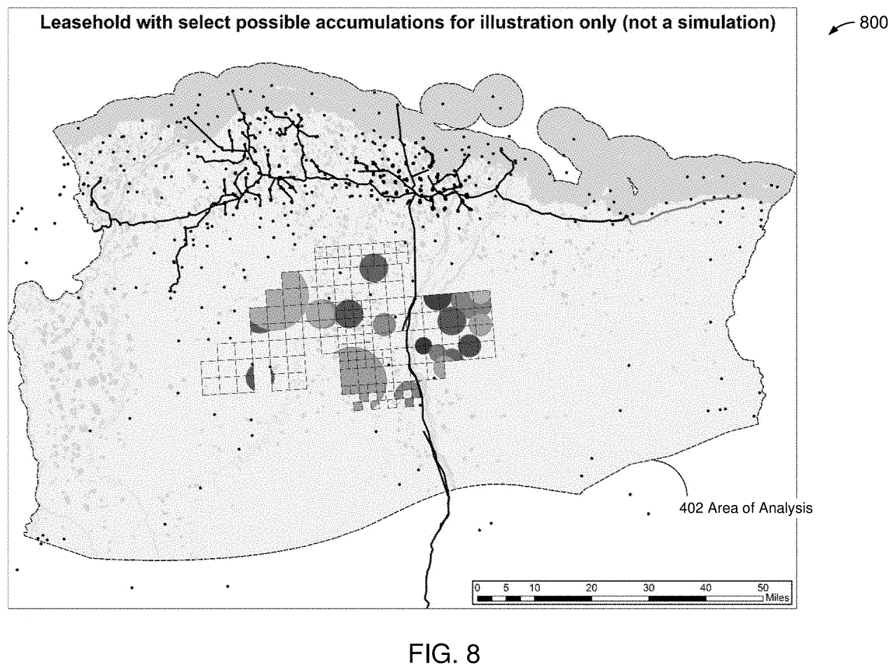

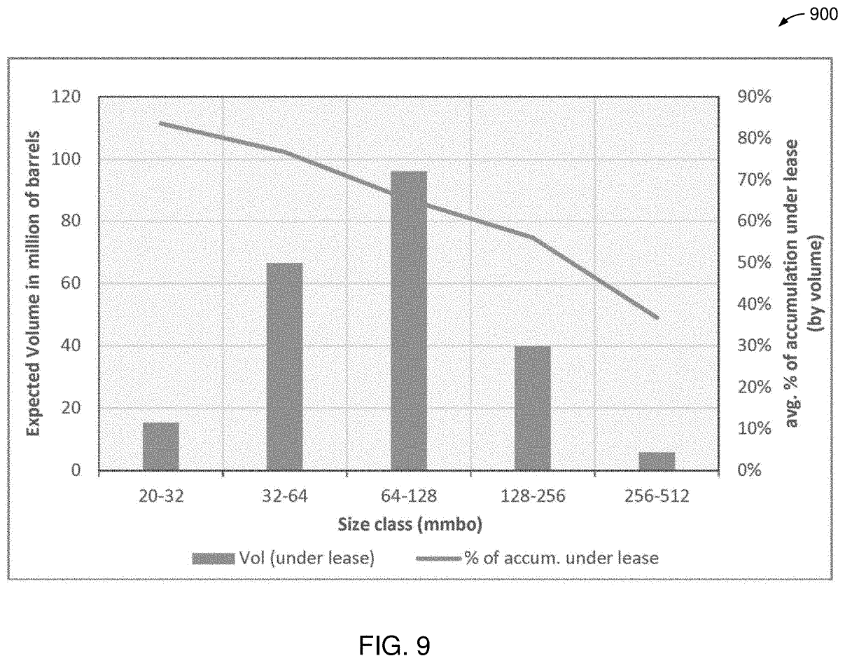

Methods and systems disclosed herein may be used to optimize ownership in undiscovered resources. As described further above, this may provide new tools to manage mineral property holdings where the location and quantity of the underlying assets are uncertain and occur within a complex landscape of other technical considerations. Businesses engaged in finding of resources such as oil and gas often invest heavily in areas with significant undiscovered resources. Often these acquisition decisions are made under great uncertainty as to how the spatial distribution of these interests intersect with this resource class in practical business terms. Even what may seem like a set of simple assumptions can be too complex for the human mind to comprehend without aid. Examples are provided below with reference to FIGS. 8 and 9.

FIG. 8 is an illustration of a geographic map 800 of area of analysis 402 (FIG. 4), to illustrate undiscovered accumulations intersecting assets of a leaseholder in terms of total volumes in each size class and volume of the percentage of the accumulation that would be contained by the leasehold. This allows the leaseholder to holistically optimize mineral property acquisition and exploration program design for such resources.

FIG. 9 is a graph 900 of expected volumes, size class, and average percentage of accumulation under lease (by volume), for the example of FIG. 8.

To evaluate how well the model predicted the actual occurrence of undiscovered accumulations, the model was tested to see how well it could predict exploration well success. Sixty-four (64) exploration wells drilled from 2004 to 2018 were used, three of which comprise discovery wells for all newly discovered accumulations. The full set of assumptions detailed in the methods outlined above and included changes to the economics layer. Each well being assigned the economic resources at the point in time it was drilled in relation to the infrastructure system. In this case the wells were ranked in terms of their modeled values for Expected Volume plotted against the success rate for the number of dry wells and discovery wells in each class. In this case the actual results were compared to the predicted values.

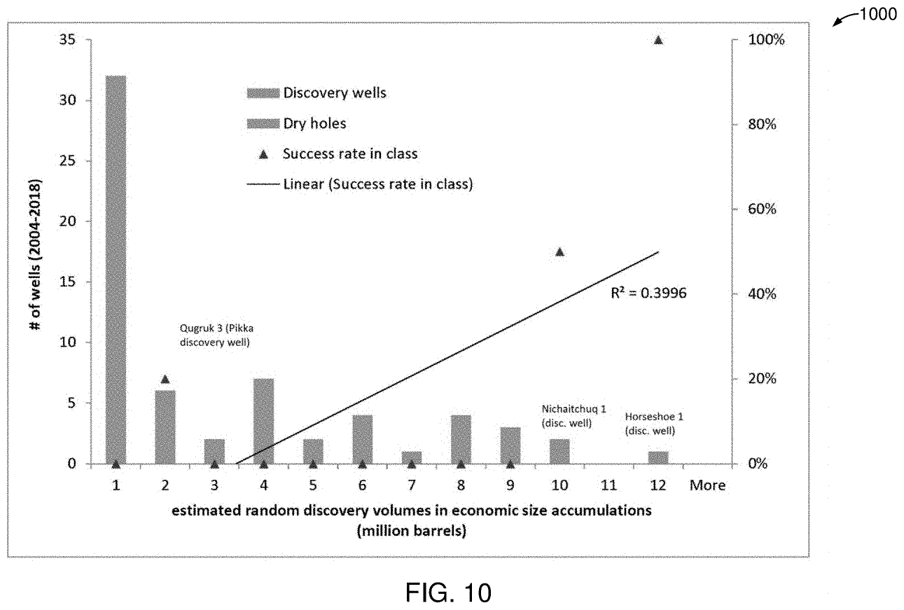

Results are illustrated in FIG. 10. FIG. 10 is a graph 1000 of regression analysis using observed success rate for wells ranked according to model predicted discovery volumes. The result is a strong correlation (R Square=0.3996), between the modeled predicted expected volumes in undiscovered accumulations and the actual success rate. The correlation also had a low p-value (p-value=0.0369), which suggests that the correlation is almost certainly real.

In addition to using expected volumes as a metric for a regression analysis, or as an alternative, the frequency of successfully finding an accumulation which meets the exploration site economics may also serve as a metric for regression analysis to discoveries.

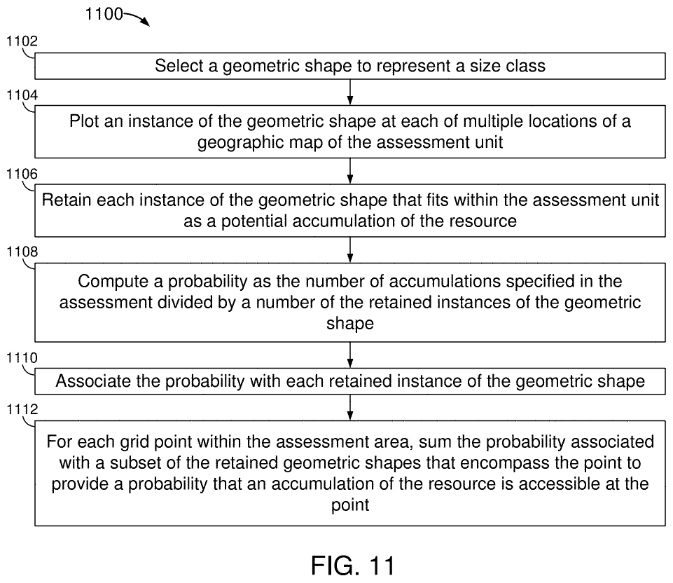

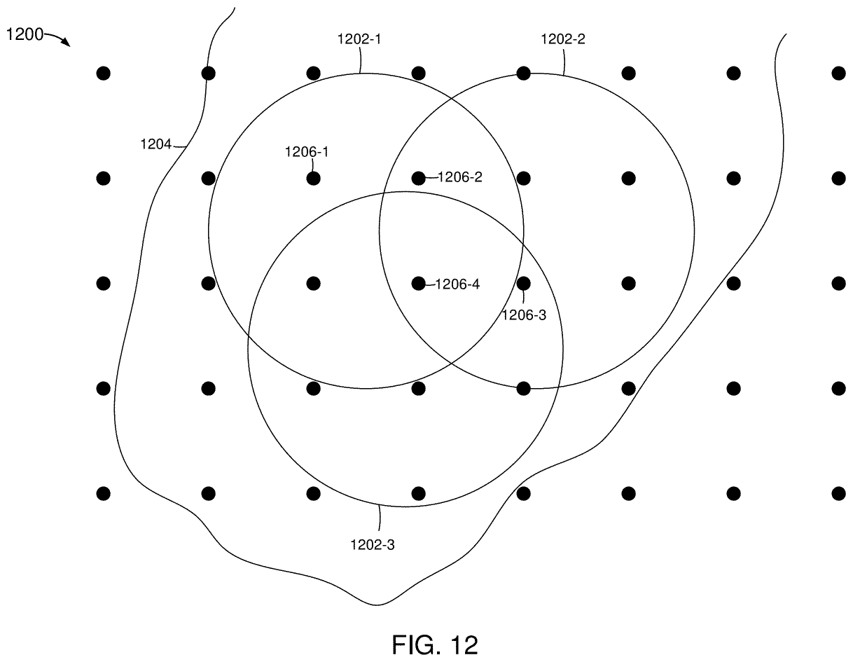

Further regarding 120 in FIG. 1, a point grid may be used as a basis from which to generate undiscovered accumulation features. Each reference location may be considered as a possible centroid of one or more classes (e.g., size classes), of undiscovered accumulation(s). An example is provided below with reference to FIGS. 11 and 12.

FIG. 11 is a process flowchart of a method 1100 of modeling modelling undiscovered accumulations, according to another embodiment. Method 1100 may be performed to model an assessment of an undiscovered resource, where the assessment specifies a number of accumulations of a size class of the resource that is theorized to exist within an assessment unit. Method 1100 is described below with reference to FIG. 12. Method 1100 is not, however, limited to the example of FIG. 12.

FIG. 12 is an illustration of a geographic map 1200 containing an assessment unit 1204 (e.g., a play), a grid of points 1206, and multiple instances of a geometric shape 1202 that fit within assessment unit 1204.

At 1102, a geometric shape is selected to represent the size class. In FIG. 12, the selected shape is a circle having a radius that is based on the size class. In another embodiment, the geometric shape may be a polygon.

At 1104, an instance of the geometric shape is plotted at each of multiple locations of a geographic map of the assessment unit.

At 1106, each instance of the geometric shape that fits within the assessment unit is retained as a potential accumulation of the resource. In FIG. 12, geometric shapes 1202-1, 1202-2, and 1202-3 are retained.

At 1108, a probability is computed as the number of accumulations specified in the assessment divided by a number of the retained instances of the geometric shape.

At 1110, the probability is associated with each retained instance of the geometric shape.

At 1112, for each grid point within the assessment unit or area, the probability associated with a subset of the retained geometric shapes that encompass the point is summed to provide a probability that an accumulation of the resource is accessible at the point.

In FIG. 12, point 1206-1 is encompassed only by geometric shape 1202-1. The probability associated with geometric shape 1202-1 is thus associated with point 1206-1.

Point 1206-2 is encompassed by geometric shapes 1202-1 and 1202-2. A sum of the probabilities associated with geometric shapes 1202-1 and 1202-2 is thus associated with point 1206-2.

Point 1206-3 is encompassed by geometric shapes 1202-2 and 1202-3. A sum of the probabilities associated with geometric shapes 1202-2 and 1202-3 is thus associated with point 1206-3.

Point 1206-4 is encompassed by geometric shapes 1202-1, 1202-2, and 1202-3. A sum of the probabilities associated with geometric shapes 1202-1, 1202-2, and 1202-3 is thus associated with point 1206-3.

In an embodiment, when a user selects (e.g., clicks or hovers a pointer over) a grid point 1206, the summed probability associated with the point is displayed.

In an embodiment, each point 1206 within assessment unit 1204 is assigned to one of multiple sets based on the summed probability associated with the respective point. For each set, a contour of the points is plotted, such as described above with reference to FIG. 5.

In an embodiment, a measure of potential accumulation of the resource (e.g., expected volume), is computed for the size class as the size class multiplied by the probability. The measure of potential accumulation is associated with each retained instance of the geometric shape (e.g., 1202-1, 1202-2, and 1202-3). For each grid point 1206 within assessment unit 1204, the measure of potential accumulation associated with the subset of the retained geometric shapes that encompass the point is summed to provide a measure of potential accumulation at the point.

Methods and systems described herein incorporate two basic processes: complete spatial randomness, where an event is equally likely to occur anywhere and individual events do not interact with each other, and stochastic geometry where objects with geometry are thought to arise randomly in a space. Together these create a random occurrence of accumulations which are geometrically constrained within complex (play) area geometries. This allows for a better local characterization where accumulations are controlled by these boundaries. Such as in this case where some locations may not provide compatible space within the play boundary for an accumulation of a certain size class.

The probability for any accumulation feature to exist is calculated by simply dividing the mean number of assessed accumulations in each size class by the number of unique possibilities (accumulation features) in each size class. This effectively produces the sum of all possible outcomes of the system presented simultaneously, or the quantum superposition of those accumulations (see quantum mechanics). So instead this modified process might be more precisely described as a spatially constrained randomness.

The assessed number of accumulations is then divided among the features generated from this process. This value is the probability that such an accumulation would randomly exist. This is the set of undiscovered accumulation features.

One or more features disclosed herein may be implemented in, without limitation, circuitry, a machine, a computer system, a processor and memory, a computer program encoded within a computer-readable medium, and/or combinations thereof. Circuitry may include discrete and/or integrated circuitry, application specific integrated circuitry (ASIC), a system-on-a-chip (SOC), and combinations thereof.

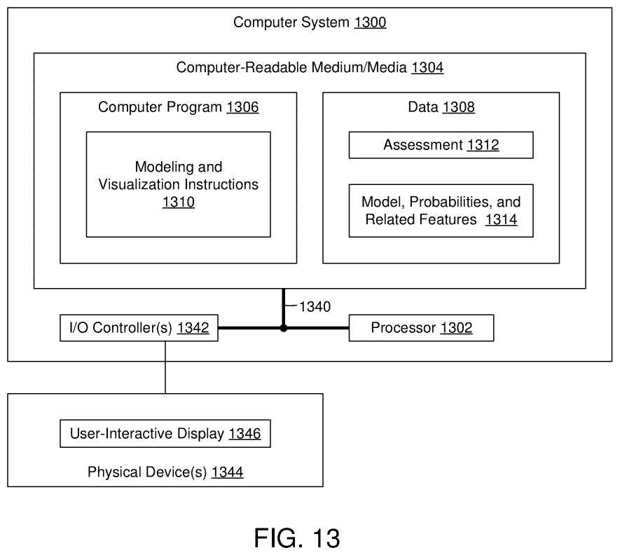

FIG. 13 is a block diagram of a computer system 1300, configured to model an assessment of an undiscovered resource.

Computer system 1300 includes one or more instruction processors, illustrated here as a processor 1302, to execute instructions of a computer program 1306 encoded within a computer-readable medium 1304. Computer-readable medium 1304 further includes data 1308, which may be used by processor 1302 during execution of computer program 1306, and/or generated by processor 1302 during execution of computer program 1306.

Computer-readable medium 1304 may include a transitory or non-transitory computer-readable medium.

In the example of FIG. 13, computer program 1306 includes modeling and visualization instructions 1310 to cause processor 1302 to model an assessment 1312 of an undiscovered resource, and to present or display the model, probabilities, and/or related features 1314, such as described in one or more examples above.

Computer system 1300 further includes communications infrastructure 1340 to communicate amongst devices and/or resources of computer system 1300.

Computer system 1300 may further includes an input/output (I/O) device and/or controller 1342 to interface with one or more other systems (e.g., physical device(s) 1344), such as to present the model, probabilities, and/or other related features 1314 on a user-interactive display 1346, such as described in one or more examples above.

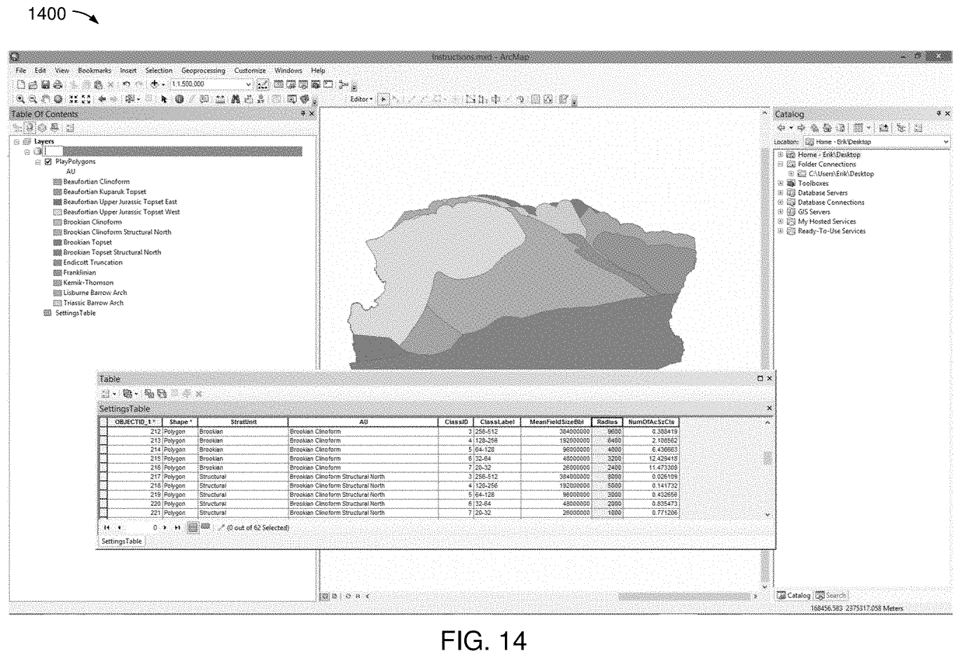

FIG. 14 is an image of a graphical user interface 1400 to a computer system, which may be presented at user-interactive display 1346 (FIG. 13).

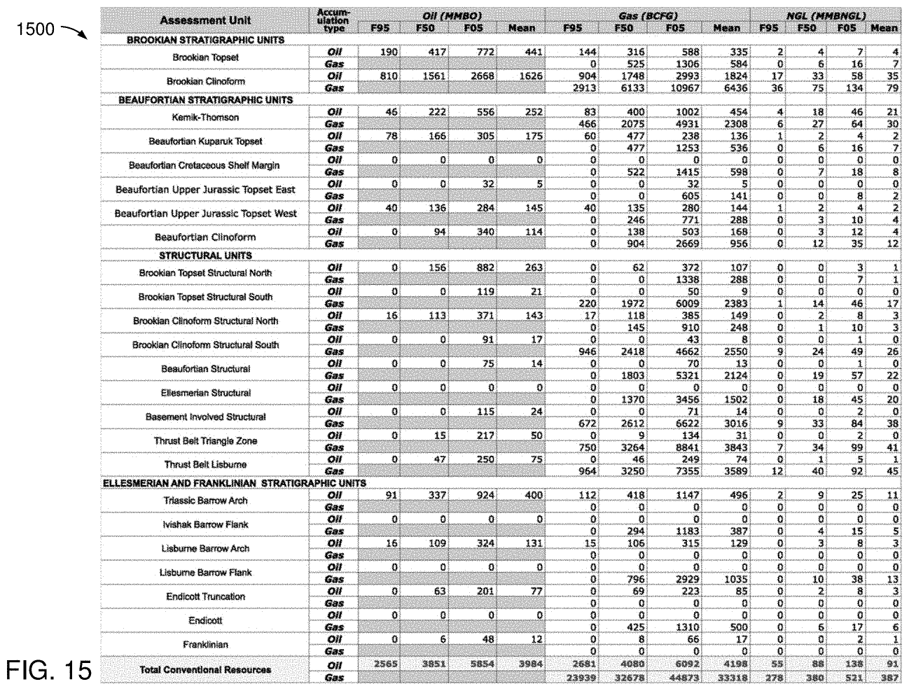

FIG. 15 illustrates an example assessment 1500 of undiscovered resources.

Disclosed herein are methods and systems to create a functional and statistically valid spatial model of undiscovered accumulations or other features. Methods and systems disclosed herein may be useful to spatial model accumulations or other features which are undiscovered but conceptualized or expected to exist within areas.

Also disclosed herein are various uses of such a model to optimize technical considerations with respect to these types of features. Features with such spatial character may be useful in a variety of fields where efforts are directed towards spatial characterization and finding of undiscovered accumulations of raw materials, physical properties, environmental contamination, organisms and energy of all types. The resulting model(s) may be useful in scientific and engineering applications related to those efforts in natural systems.

Among other uses, techniques disclosed herein may be used to generate estimates for probabilities for the occurrence of hydrocarbon accumulations in an area of interest and the resulting spatial distribution of those as volumes. This may aid in investments in mineral interests as well as exploration program design. Techniques disclosed herein may also be used in situations involving potential environmental contamination in an area of interest and aid in design of programs to efficiently reduce the probability of undiscovered accumulations of contaminants to exist.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. A method of modeling an assessment of an undiscovered resource, wherein the assessment specifies a number of accumulations of a size class of the undiscovered resource that is theorized to exist within an assessment unit, comprising:
selecting a geometric shape to represent the size class;
plotting an instance of the geometric shape at each of multiple locations of a geographic map of the assessment unit;
retaining each instance of the geometric shape that fits within the assessment unit as a potential accumulation of the undiscovered resource;
computing a probability as the number of accumulations specified in the assessment divided by a number of the retained instances of the geometric shape;
associating the probability with each retained instance of the geometric shape; and
for each grid point within the assessment unit, summing the probability associated with retained geometric shapes that encompass the point to provide a summed probability that an accumulation of the undiscovered resource is locatable at the grid point.

2. The method of claim 1, further including:
identifying points of the grid for which the summed probabilities are within a predetermined range or a selectable range; and
plotting a geographical contour of the identified points on a user-interactive geographic map of the assessment unit.

3. The method of claim 1, further including:
computing a measure of potential accumulation of the undiscovered resource for the size class as the size class multiplied by the probability;
associating the measure of potential accumulation with each retained instance of the geometric shape; and
for each grid point within the assessment unit, summing the measure of potential accumulation associated with the subset of the retained geometric shapes that encompass the point to provide a measure of potential accumulation at the point.

4. The method of claim 3, wherein the computing a measure of potential accumulation includes:
computing an expected value for a quantity of the undiscovered resource for the size class as the quantity of the potential accumulation multiplied by the probability.

5. The method of claim 3, further including:
identifying points of the grid for which the measures of potential accumulation are within a predetermined range or a selectable range; and
plotting a geographical contour of the identified points on a user-interactive geographic map of the assessment unit.

6. The method of claim 1, further including:
modifying the probability of a retained instance of the geometric shape based on a location of the retained instance of the geometric shape.

7. The method of claim 1, further including:
modifying the probability associated with an instance of the geometric shape if a geographic region of the instance of the geometric shape encompasses a testing agent configured to locate the accumulation with some efficiency.

8. An apparatus to model an assessment of an undiscovered resource, wherein the assessment specifies a number of accumulations of a size class of the undiscovered resource that is theorized to exist within an assessment unit, the apparatus comprising a processor and memory configured to:
select a geometric shape to represent the size class;
plot an instance of the geometric shape at each of multiple locations of a geographic map of the assessment unit;
retain each instance of the geometric shape that fits within the assessment unit as a potential accumulation of the undiscovered resource;
compute a probability as the number of accumulations specified in the assessment divided by a number of the retained instances of the geometric shape;
associate the probability with each retained instance of the geometric shape; and
for each grid point within the assessment unit, sum the probability associated with retained geometric shapes that encompass the point to provide a summer probability that an accumulation of the undiscovered resource is locatable at the grid point.

9. The apparatus of claim 8, wherein the processor and memory are further configured to:
identify points of the grid for which the summed probabilities are within a predetermined range or a selectable range; and
plot a geographical contour of the identified points on a user-interactive geographic map of the assessment unit.

10. The apparatus of claim 8, wherein the processor and memory are further configured to:
compute a measure of potential accumulation of the undiscovered resource for the size class as the size class multiplied by the probability;
associate the measure of potential accumulation with each retained instance of the geometric shape; and
for each grid point within the assessment unit, sum the measure of potential accumulation associated with the subset of the retained geometric shapes that encompass the point to provide a measure of potential accumulation at the point.

11. The apparatus of claim 10, wherein the processor and memory are further configured to:
compute an expected value for a quantity of the undiscovered resource for the size class as the quantity of the potential accumulation multiplied by the probability.

12. The apparatus of claim 10, wherein the processor and memory are further configured to:
identify points of the grid for which the measures of potential accumulation are within a predetermined range or a selectable range; and
plot a geographical contour of the identified points on a user-interactive geographic map of the assessment unit.

13. The apparatus of claim 8, wherein the processor and memory are further configured to:
modify the probability of a retained instance of the geometric shape based on a location of the retained instance of the geometric shape.

14. The apparatus of claim 8, wherein the processor and memory are further configured to:
modify the probability associated with an instance of the geometric shape if a geographic region of the instance of the geometric shape encompasses a testing agent configured to locate the accumulation with some efficiency.

15. A non-transitory computer readable medium encoded with a computer program, including instructions to cause a processor to model an assessment of an undiscovered resource, wherein the assessment specifies a number of accumulations of a size class of the undiscovered resource that is theorized to exist within an assessment unit, including to:
select a geometric shape to represent the size class;
plot an instance of the geometric shape at each of multiple locations of a geographic map of the assessment unit;
retain each instance of the geometric shape that fits within the assessment unit as a potential accumulation of the undiscovered resource;
compute a probability as the number of accumulations specified in the assessment divided by a number of the retained instances of the geometric shape;
associate the probability with each retained instance of the geometric shape; and
for each grid point within the assessment unit, sum the probability associated with retained geometric shapes that encompass the point to provide a summed probability that an accumulation of the undiscovered resource is locatable at the grid point.

16. The non-transitory computer-readable medium of claim 15, further including instructions to cause the processor to:
identify points of the grid for which the summed probabilities are within a predetermined range or a selectable range; and
plot a geographical contour of the identified points on a user-interactive geographic map of the assessment unit.

17. The non-transitory computer-readable medium of claim 15, further including instructions to cause the processor to:
compute a measure of potential accumulation of the undiscovered resource for the size class as the size class multiplied by the probability;
associate the measure of potential accumulation with each retained instance of the geometric shape; and
for each grid point within the assessment unit, sum the measure of potential accumulation associated with the subset of the retained geometric shapes that encompass the point to provide a measure of potential accumulation at the point.

18. The non-transitory computer-readable medium of claim 17, further including instructions to cause the processor to:
compute an expected value for a quantity of undiscovered resource for the size class as the quantity of the potential accumulation multiplied by the probability.

19. The non-transitory computer-readable medium of claim 17, further including instructions to cause the processor to:
identify points of the grid for which the measures of potential accumulation are within a predetermined range or a selectable range; and
plot a geographical contour of the identified points on a user-interactive geographic map of the assessment unit.

20. The non-transitory computer-readable medium of claim 15, further including instructions to cause the processor to:
modify the probability of a retained instance of the geometric shape based on a location of the retained instance of the geometric shape.
